(19) United States
(12) Patent Application Publication
(10) Pub. No.: US 2008/0298857 A1
(43) Pub. Date: Dec. 4, 2008

(54) INTERMEDIATE TRANSFER BELT UNIT USE IN IMAGE FORMING APPARATUS

(75) Inventor: Sadahiro Masuda, Mishima-shi (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/129,315

(22) Filed: May 29, 2008

Related U.S. Application Data
(60) Provisional application No. 60/940,945, filed on May 30, 2007.

(51) Int. Cl. G03G 15/01

(52) U.S. Cl. 399/302

(57) ABSTRACT

This invention provides an image forming apparatus including a belt member which is shaped like a belt and has a belt surface and to which a toner image corresponding to image data is transferred, a roller member for moving the belt surface at a constant velocity in a predetermined direction while giving a predetermined tension to the belt member, a roller drive device which rotate the roller member at a predetermined rotational velocity, and a drive force stabilizing device which is located between the roller member and a structural body supporting the roller member and which absorb a rotation irregularity component or a velocity change occurring in the belt member.

### CROSS-REFERENCE TO RELATED APPLICATIONS

This application claims the benefit of U.S. Provisional Application No. 60/940,945, filed May 30, 2007.

### BACKGROUND OF THE INVENTION

1. Field of the Invention

The present invention relates to an electrophotographic type image forming apparatus in which toner images stacked in accordance with single color images corresponding to color components obtained by color separation are fixed onto a transfer material (sheet material) to thereby obtain a color image output.

2. Description of the Related Art

In an electrophotographic type color image forming apparatus, a predetermined surface potential is given to a photoconductor capable of holding an electrostatic latent image to selectively change the surface potential of part of the photoconductor corresponding to a background portion or an image portion to thereby form an electrostatic latent image (on the photoconductor), and toner images obtained by visualizing agents (toners) supplied to the electrostatic latent image are transferred onto an output medium (transfer material).

For example, in JP-A-2005-227509, there has been disclosed an image forming apparatus in which an intermediate transfer belt is driven at a contact part between an image bearing member and the intermediate transfer belt, and in addition to main drive means for giving a main drive force to the intermediate transfer belt, there is provided auxiliary drive means for giving an auxiliary drive force to the intermediate transfer belt in the condition that the auxiliary drive force is not smaller than a load variation of the intermediate transfer belt caused by contact and separation of a load member to the intermediate transfer belt and is smaller than the main drive force.

However, since the image forming apparatus disclosed in JP-A-2005-227509 requires the main drive means for giving the main drive force to rotate the intermediate transfer belt and the auxiliary drive means for giving the auxiliary drive force for rotation-driving the intermediate transfer belt to the intermediate transfer belt at a portion other than the image bearing member, a control device and various sensors for the auxiliary drive means are required so that the structure of the image forming apparatus becomes complicated and the cost becomes high.

### BRIEF SUMMARY OF THE INVENTION

An object of the present invention is to provide an image forming apparatus with an inexpensive and simple structure in which occurrence of a color shift is prevented.

The invention provides an image forming apparatus comprising: a toner image holding unit configured to hold a toner image corresponding to image data; a toner image holding unit drive mechanism configured to move the toner image holding unit at a constant velocity in a predetermined direction; a drive force generating unit configured to provide a thrust to rotate the toner image holding unit drive mechanism at a predetermined rotational velocity; and a drive force control unit configured to provide the thrust generated by the drive force generating unit to the toner image holding unit drive mechanism while keeping the thrust in a constant thrust range.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic view showing an example of an image forming apparatus to which an embodiment of the invention is applied;

FIG. 2 is a schematic view for explaining an example of a control system and a drive system in the color image forming apparatus described on the basis of FIG. 1;

FIG. 3 is a schematic view for explaining an intermediate transfer belt unit incorporated in the color image forming apparatus described on the basis of FIGS. 1 and 2;

FIG. 4 is a schematic view for explaining a state where an intermediate transfer belt has been removed from the intermediate transfer belt unit shown in FIG. 3 (a drive roller is exposed);

FIG. 5 is a partly enlarged view for explaining a state where a torque limiter to be incorporated in the transfer belt unit for traveling a drive roller shown in FIG. 4 is attached; and

FIG. 6 is a schematic view for explaining another example of the drive system (mechanism for rotating the drive roller) in the color image forming apparatus described with reference to FIG. 2.

### DETAILED DESCRIPTION OF THE INVENTION

An embodiment of the invention will be described below in detail by way of example with reference to the drawings.

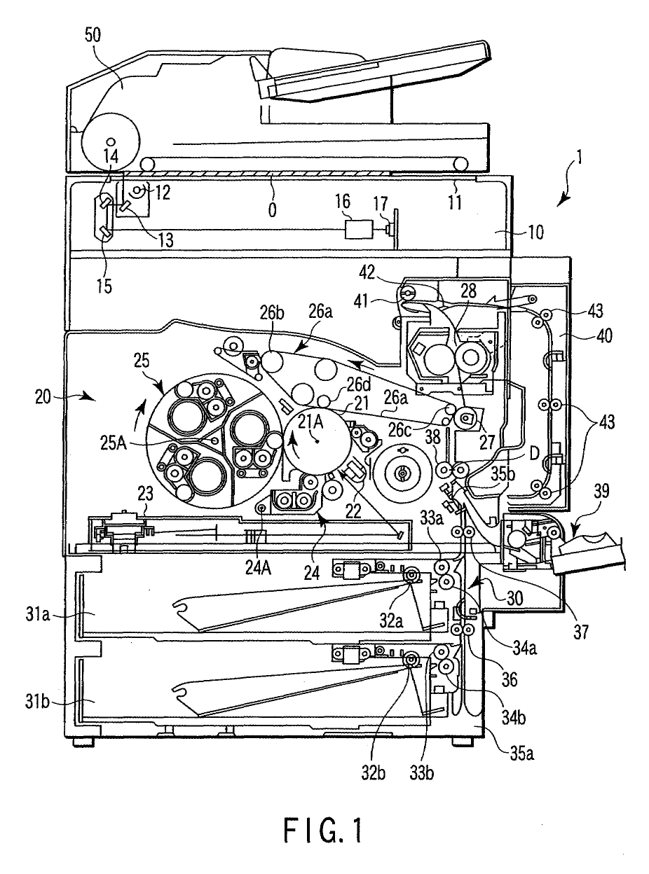

FIG. 1 is a schematic view showing an example of an image forming apparatus to which the embodiment of the invention is applied.

As shown in FIG. 1, an image forming apparatus 1 includes an image reader portion 10, an image forming portion 20, a paper supply portion 30, and an automatic document feeder (ADF) 50. The image reader portion 10 captures image information of a subject of copying (reading) as brightness and darkness of light and outputs a signal corresponding to the image information, that is, image data. The image forming portion 20 forms a copy image, that is, an output image, based on the image data generated by the image reader portion 10. The paper supply portion 30 supplies and feeds an output medium to the image forming portion 20. When the subject of copying is a sheet-like subject, the automatic document feeder (ADF) 50 replaces the subject of copying with a new one whenever an image based on the image data generated by the image reader portion 10 is outputted from the image forming portion 20.

The image reader portion 10 includes an original document table 11, an illuminator 12, first to third mirrors 13, 14 and 15, a lens 16, and a CCD sensor 17. The original document table 11 holds a subject of copying (reading) not shown. The illuminator 12 illuminates a subject set on the original document table 11. The first to third mirrors 13, 14 and 15 guide reflected light from the subject illuminated by the illuminator 12, that is, image light, toward the CCD sensor 17 successively. The lens 16 gives a predetermined imaging magnification to the image light guided (to the lens 16) by the first to third mirrors 13, 14 and 15. The CCD sensor 17 receives the image light to which the predetermined imaging magnification is given by the lens 16, and outputs image data corresponding to the image light.

The image forming portion 20 includes a photoconductor 21, a main electrostatic charging unit 22, an exposing unit 23, a black (first) developing unit 24, a color (second) developing unit 25, an intermediate transfer unit 26, a transfer unit 27, and a fuser unit 28.

The photoconductor 21 holds an electrostatic latent image generated by irradiation of light in a state where the photoconductor 21 is electrostatically charged in advance. The main electrostatic charging unit 22 gives a predetermined surface potential to the photoconductor 21. The exposing unit 23 irradiates the photoconductor 21 with light to which an intensity distribution corresponding to the image data is given, in a state where the predetermined surface potential is given to the photoconductor 21 by the main electrostatic charging unit 22.

The black (first) developing unit 24 supplies a black (BK) toner selectively to the latent image formed on the photoconductor 21.

The color (second) developing unit 25 supplies C (Cyan), M (Magenta) and Y (Yellow) toners in predetermined order and selectively to the electrostatic latent image formed on the photoconductor 21.

The intermediate transfer unit 26 includes an intermediate transfer belt 26a, at least two roller members 26b and 26c for giving a predetermined tension to the intermediate transfer belt 26a, and an intermediate transfer member 26d for giving a predetermined electric field to the intermediate transfer belt 26a as will be described below. The intermediate transfer belt 26a of the intermediate transfer unit 26 holds a BK toner image, a C toner image, an M toner image and a Y toner image formed on the photoconductor 21, in a stacked state.

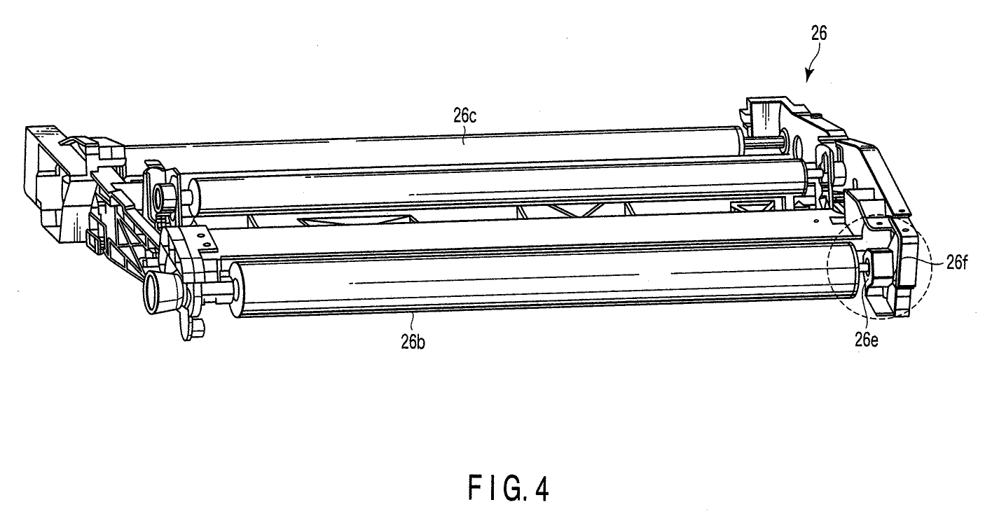

At least one of the roller members 26b and 26c (the roller member 26b on a side where it does not come into contact with the transfer unit 27 in this embodiment) is formed so that a predetermined amount of drive force or bias power, especially unchanged drive force, can be provided to the intermediate transfer belt 26a. For example, the roller member 26b is formed so as to be integrated with a torque limiter 26e as shown in FIGS. 4 and 5. Incidentally, the torque limiter 26e is provided between the roller member 26b and a structural body (frame member) 26f of the intermediate transfer unit 26, that is, at an end portion on a side opposite to a side where a drive force is given (to the roller member 26b), so that the torque limiter 26e serves as a kind of shaft bearing. The torque limiter 26e provides a constant drag force (braking force or reaction) against the turning force provided to the roller member 26b.

The transfer unit 27 transfers a color toner image superimposed on the transfer belt 26a to an output medium.

The fuser unit 28 fixes (fuses) the color toner image transferred to the output medium, on the output medium.

Since the photoconductor 21 is shaped like a cylinder (drum) in this embodiment of the invention, the photoconductor 21 is hereinafter referred to as photoconductive drum. Various representative sheet materials such as a sheet paper with a predetermined thickness, a transparent resin sheet, a pressure sensitive adhesive sheet having one surface coated with a pressure sensitive adhesive agent, etc. can be used as the output medium.

The transfer charge supply roller 26d is located on the inside of the intermediate transfer belt 26a at a position where the intermediate transfer belt 26a and the photoconductive drum 21 come into contact with each other. The transfer charge supply roller 26d provides an electric field for transferring toner images formed on the photoconductive drum 21 to the intermediate transfer belt 26a, to the intermediate transfer belt 26a.

For example, as will be described later, the torque limiter 26e can suppress a toner image of any color carried by movement of the transfer belt 26a from being transferred to a position shifted from that of toner images of other colors as caused by a variation of velocity when an arbitrary position of the transfer belt 26a is moved at a constant velocity. That is, the torque limiter 26e can reduce the influence of a variation of belt velocity which may occur, for example, at the moment that the transfer unit 27 apart from the transfer belt 26a after the transfer unit 27 comes into contact with the transfer belt 26a to transfer a color toner image to a sheet material, since a predetermined amount of drive force or bias power, especially unchanged drive force, can be provided to the intermediate transfer belt 26a.

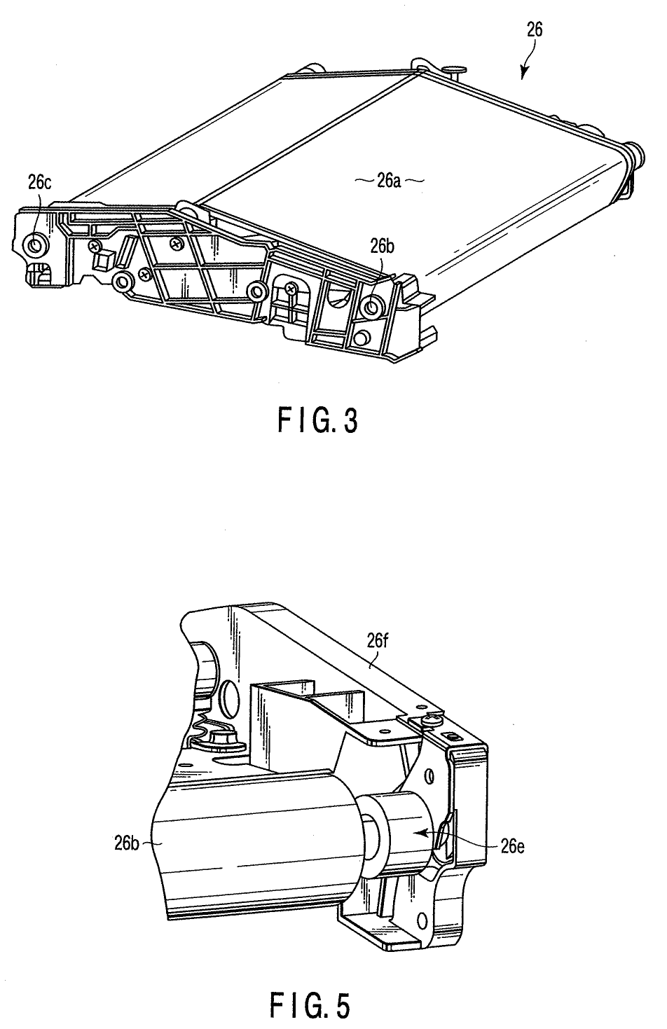

As shown in FIGS. 3 to 5, the torque limiter 26e gives a predetermined amount of load (continuously) to a shaft of the roller member 26b giving a predetermined tension to the transfer belt 26a, so that the torque limiter 26e can suppress a vibration (variation/the transfer belt 26a moving velocity is unstabilized) of the transfer belt 26a which may occur at the aforementioned moment of retracting the transfer unit 27 apart from the transfer belt 26a after pressing the transfer unit 27 against the transfer belt 26a, from being transmitted to a transfer position where the photoconductive drum 21 and the intermediate transfer member 26d come into contact with each other. That is, the torque limiter 26e can improve stability of velocity when an arbitrary position of the transfer belt 26a is moved at a constant velocity (can absorb irregularity of velocity).

That is, the provision of the drive control means (torque limiter) 26e directly on the shaft of the drive roller 26b giving a drive force (to the intermediate transfer belt 26a) in order to move the intermediate transfer belt 26a at a predetermined belt movement velocity makes it possible to positively control rotation of the drive roller 26b so as to obtain stable rotation (belt velocity) of the intermediate transfer belt 26a.

Accordingly, a variation of load at the time of rotation of the intermediate transfer belt 26a, which becomes the cause of a color shift, can be reduced in a color image forming apparatus of the type in which toner images are superimposed on one another. The use of this means (torque limiter) eliminates the need of the auxiliary drive means which appeared to be given, for example, to the intermediate transfer belt, so that the use of this means (torque limiter) makes it possible to provide an image forming apparatus with an inexpensive and simple structure in which the color shift hardly occurs. That is, such a cost-required configuration that a flywheel is attached to a drive motor of the drive roller of the intermediate transfer belt unit to stabilize rotation of the drive motor and that a function of automatically correcting the incurred color shift at predetermined timing is provided is unnecessary, so that the image forming apparatus is free from increase of the cost and complication of control due to increase in number of parts.

In the paper supply portion 30, there are provided first and second slots 31a and 31b into which cassettes each containing output media of an arbitrary size are inserted respectively, first and second pickup rollers 32a and 32b for leading out sheet papers contained in the cassettes from the cassettes inserted into the slots 31a and 31b toward a carrying path which will be described below, first and second paper feed rollers 33a and 33b for separating the sheet papers led out by the first and second pickup rollers 32a and 32b into a sheet paper by a difference between a frictional force between sheet papers and a frictional force between paper and each roller, a paper holding portion 35a including separation rollers 34a and 34b being in contact with the paper feed rollers respectively, and a paper carrying portion 35b for feeding a sheet paper led out from an arbitrary cassette toward the image forming portion 20.

In the paper carrying portion 35b, there are provided a first intermediate carrying roller 36 for carrying a sheet paper contained in the cassette set in the slot located on a side separated from the image forming portion 20, toward the image forming portion 20, a second intermediate carrying roller 37 for feeding the sheet paper toward the image forming portion 20 in a path between the first intermediate carrying roller 36 and the image forming portion 20, and an aligning roller 38 for aligning the position of the sheet paper with the position of the color toner image superimposed on the intermediate transfer belt 26a while stopping the sheet paper temporarily on an upstream side of the transfer unit 26.

In the paper carrying portion 35b, there are further provided a manual paper feed unit 39 which can be used for feeding a predetermined number of sheet papers, OHP sheets or the like, and a connection portion by which the sheet papers or OHP sheets set in the manual paper feed unit 39 can be guided toward the aligning roller 38.

On a downstream side of the fuser unit 28, there is provided a reversing unit 40 from which the output medium with the color toner image fixed by the fuser unit 28 can be discharged to a copy receiving portion provided as a space between the image reader portion 10 and the image forming portion 20 and by which the output medium (the sheet paper) with the color toner image having been already fixed to its one surface is turned upside down if necessary. In the reversing unit 40, there are provided a discharging and reversing roller 41 for guiding the sheet paper instructed to be turned upside down (for copying on both surfaces) to the reversing unit 40 while outputting the sheet paper (output medium) having no continuous image formation (image formation and fixing has been finished) to the copy receiving portion, a switching unit 42 for guiding the sheet paper fed out toward the reversing unit 40 by the discharging and reversing roller 41, and carrying rollers 43, . . . , 43 for carrying the sheet paper supplied to the reversing unit 40 toward the aligning roller 38.

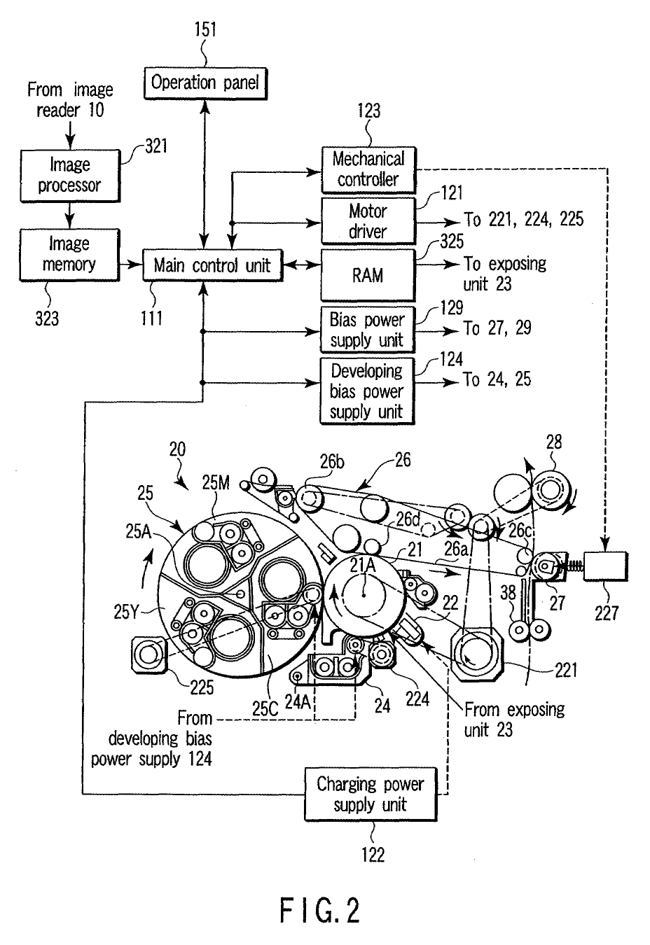

In the image forming apparatus 1 shown in FIG. 1, when a subject of copying (hereinafter referred to as original document) is set on the original document table 11 through the ADF 50 or directly and an instruction to start copying is given from an operation panel 151 (see FIG. 2), illumination light is radiated from the illuminator 12 at predetermined timing to illuminate the original document O. As a result, reflected light including image information of the original document as brightness and darkness of light is extracted. The reflected light is hereinafter referred to as image light.

The image light is guided to the lens 16 by the first to third mirrors 13 to 15 and a predetermined imaging magnification is given to the image light by the lens 16, so that the image light forms an image on the CCD sensor 17.

The image light as an image formed on the CCD sensor 17 is photoelectrically converted by the CCD sensor and further converted into image data by an image processor portion 321 (see FIG. 2), so that the image data is stored in an image memory 323 (see FIG. 2).

A predetermined electric potential is given to the surface of the photoconductive drum 21 by the electrostatic charging unit 22 at predetermined timing based on the start of the illuminator 12 to illuminate the original document.

The image light with a change of intensity based on the image data is irradiated onto the photoconductive drum 21 from the exposing unit 23, so that the surface potential of the photoconductive drum 21 supplied with the predetermined surface potential by the electrostatic charging unit 22 is selectively changed. The potential difference on the photoconductive drum 21 is held as an electrostatic latent image on the photoconductive drum 21 for a predetermined time.

When the electrostatic latent image held on the photoconductor drum 21 is a latent image corresponding to a black (BK) image, a black toner is supplied from the BK developing unit 24 to thereby develop the latent image to a visual image.

When the electrostatic latent image held on the photoconductive drum 21 is a latent image corresponding to an image of any color component other than black, a predetermined color toner is supplied from a developing unit holding a corresponding color toner in the color developing unit 25 to thereby develop the latent image to a visual image. The color developing unit 25 is of the type in which three developing units (25C, 25M and 25Y) independently containing toners capable of visualizing three color components obtained by color separation based on the commonly known subtractive process are formed so as to be rotatable around a rotation shaft 25A, and which is called revolver type.

A (single color) toner image formed on the photoconductive drum 21 is carried to an intermediate transfer position in contact with the transfer belt 26a is transferred onto the transfer belt 26a by a predetermined transfer bias voltage supplied from the intermediate transfer member 26d inside the transfer belt 26a. When the required image output (hard copy) is color, a C toner image, an M toner image and a Y toner image formed by the color developing unit 25 are successively transferred onto the BK toner image formed by the black developing unit 24.

When the four single color toner images are transferred onto the transfer belt 26a so as to be superimposed on one another, the output medium (the sheet paper or OHP sheet) guided to the aligning roller 38 at predetermined timing is carried to a transfer position where the transfer belt 26a and the transfer unit 27 come into contact with each other and an output transfer bias voltage is supplied from the transfer unit 27 to thereby transfer all toner images, that is, a color toner image, to the output medium.

The transfer unit 27 can be changed by a gap holding mechanism 227 (see FIG. 2) to come into contact with the transfer belt 26a or to be separated from the transfer belt 26a. At the time of non-transfer, the transfer unit 27 is placed in a retreat position where a predetermined gap is given between the transfer unit 27 and the transfer belt 26a so that the toner images stacked on the transfer belt 26a are not attracted.

The color toner (BK+C+M+Y) image which is a mixture of toner images transferred to the output medium such as a sheet paper or an OHP sheet is guided to the fuser unit 28 in accordance with carrying of the output medium.

The mixture of toner images (color toner image) guided to the fuser unit 28 is heated together with the output medium by heat from the fuser unit 28 to thereby be fused, and is supplied with a predetermined pressure in the fuser unit 28 to thereby be fixed (fused) to the output medium.

Sheet papers (output media) are taken out one by one from a cassette contained in the first or second slot 31a or 31b or from the manual paper feed unit 39, so that a sheet paper is carried to the aligning roller 38 in advance.

The sheet paper carried to the aligning roller 38 collides with the aligning roller 38 whose rotation is stopped, so that the sheet paper is stopped temporarily in a state where a component not parallel to the carrying direction, that is, an inclination which may be generated when the sheet paper is led out from the paper holding portion 35a or when the sheet paper is carried in the paper carrying portion 35b.

FIG. 2 shows an example of a control system in the color image forming apparatus described with reference to FIG. 1.

An original document is set on the original document table 11 and an instruction to start copying is given from the operation panel 151, so that image data corresponding to an image of the original document is obtained in the image reader portion 10.

The image data is stored in the image memory 323 after processed by the image processor portion 321 in accordance with an image processing routine determined in advance.

In the image forming portion 20 and the paper supply portion 30, a motor 221 for rotating the rotation center 21A of the photoconductive drum 21 and the drive shaft (roller) 26b of the transfer belt 26a in a predetermined direction is rotated at a predetermined rotational velocity by control of a main control unit 111 at predetermined timing corresponding to the start of the image reader portion 10 to read the image of the original document. The motor 221 is also used for driving a heating roller or a heating belt (not shown in detail) in the fuser unit 28 and rotating a roller member (not shown in detail) in the transfer unit 27. As another example, a roller in the paper supply portion 30 can be also rotated by the motor 221.

The motor 221 is rotated at a predetermined rotational velocity in accordance with a predetermined number of motor drive pulses inputted to a motor driver 121 from the main control unit 111. The rotation of the motor 221 is transmitted to the rotation center 21A of the photoconductive drum 21 and the drive shaft 26b of the transfer belt 26a by a transmission mechanism not shown. As a result, any position on the circumference of the photoconductive drum 21 and any position on the outer circumference of the transfer belt 26a are moved at one and the same velocity.

A predetermined voltage and a predetermined current are supplied to the electrostatic charging unit 22 from a charging power supply unit 122 at predetermined timing corresponding to the rotation start of the motor 221, so that a predetermined surface potential is given to the photoconductive drum 21 from the electrostatic charging unit 22.

A developing bias voltage with a predetermined amount and a predetermined polarity is applied to a developing roller of the black developing unit 24 from a developing bias power supply 124 at predetermined timing corresponding to the start of electrostatic charging of the photoconductive drum 21 by the electrostatic charging unit 22. At the same time or at predetermined timing, a black developing motor 224 is rotated so that the developing roller of the black developing unit 24 is rotated. The black developing unit 24 is located in a black developing position where a predetermined gap is formed between the surface of the photoconductive drum 21 and the surface of the developing roller, with the rotation center 24A as its rotation axis by a black developing position control mechanism not shown.

Then, black image data stored in the image memory 323 is converted into exposure (serial) data for forming an electrostatic latent image on the photoconductive drum 21, at predetermined timing (exposure timing) defined based on a marker (not shown) or the like, for example, provided in any position of a belt surface or a back surface (inside) of the transfer belt 26a. The exposure (serial) data is supplied to the exposing unit 23. A commonly known method, such as expansion to a page memory (RAM) 325 in which a storage capacity corresponding to one page of the image output is secured, and transmission of expanded parallel data to the exposing unit 23 in accordance with one line, is used for the conversion of image data into serial data.

An electrostatic image (electrostatic latent image) of the black image is formed on the photoconductive drum 21 in accordance with black (BK) image light irradiated onto the photoconductive drum 21 from the exposing unit 23. The black electrostatic latent image is developed by the black developing unit 24. As a result, a black (BK) toner image is formed on the photoconductive drum 21.

After a predetermined time has passed (black image exposure has been finished) from the point of time when the black image data temporarily stored in the RAM 325 was transmitted to the exposing unit 23, the black developing unit 24 is made to retract from the black developing position to a predetermined retreat position in accordance with an instruction (control command) from the main control unit 111. The supply of the developing bias voltage due to the developing bias power supply 124 and the rotation of the developing roller due to the black developing motor 224 are stopped at predetermined timing.

The black toner image formed on the photoconductive drum 21 is guided to an intermediate transfer position where the photoconductive drum 21 and the transfer belt 26a come into contact with each other, in accordance with rotation of the photoconductive drum 21.

The black toner image guided to the intermediate transfer position comes into contact with the transfer belt 26a in the transfer belt 26a, and the black toner image is transferred (attracted) to the transfer belt 26a by a transfer electric field from the intermediate transfer member 26d supplied with a black intermediate transfer bias voltage Vtbk with a predetermined amount and a predetermined polarity by a bias power supply unit 129.

The black toner image transferred to the transfer belt 26a is moved successively in accordance with movement of the belt surface of the transfer belt 26a, that is, in accordance with rotation of the drive shaft 26b. The transfer unit 27 can be located either in a transfer position where the transfer unit 27 is pressed against the outer circumferential surface of the transfer belt 26a or in a non-transfer position where the transfer unit 27 is separated from the transfer belt 26a, by a pressing mechanism 227 which is operated by a mechanical controller 123 to press a roller member (not shown in detail) against the transfer belt 26a or separate the roller member from the transfer belt 26a. In this case, the transfer unit 27 is made to retreat to the non-transfer position. Accordingly, the black toner image is carried toward the intermediate transfer position again in accordance with movement (rolling) of the belt surface of the transfer belt 26a.

While the surface of the photoconductive drum 21 after the transfer of the black toner image to the transfer belt 26a is cleaned by a drum cleaner (not shown in detail) so that a remaining toner not transferred to the transfer belt 26a is removed from the surface of the photoconductive drum 21, the surface potential of the photoconductive drum 21 is returned (reset) to the potential distribution before a predetermined potential is given from the electrostatic charging unit 22, by a charge eliminating unit (not shown in detail).

Subsequently, the developing roller of any developing unit in the color developing unit 25 is located in a color developing position facing a predetermined position on the outer circumference of the photoconductive drum 21 by rotation of a color developing unit rotating motor not shown or transmission of a drive force from the motor 221 due to a transmission mechanism not shown, in accordance with an instruction given by the main control unit 111 to form a color image.

When, for example, the image to be stacked on the black toner image is a C (cyan) image, the color developing unit 25 is rotated around the center shaft 25A, for example, in a CW (arrow) direction until the developing roller of the cyan (C) developing unit 25C in the color developing unit 25 faces the photoconductive drum 21. Subsequently, a predetermined voltage and a predetermined current are supplied to the electrostatic charging unit 22 from the charging power supply unit 122 so that a predetermined surface potential is given to the photoconductive drum 21 again.

A developing bias voltage with a predetermined amount and a predetermined polarity is applied to the developing roller of the cyan (C) developing unit 25C from the developing bias power supply 124 at predetermined timing corresponding to the start of electrostatic charging of the photoconductive drum 21 by the electrostatic charging unit 22. At the same time or at predetermined timing, the color developing motor 225 is rotated so that the developing roller of the cyan (C) developing unit 25C is rotated.

Then, C (cyan) image data stored in the image memory 323 is converted into exposure (serial) data for forming an electrostatic latent image on the photoconductive drum 21 by the RAM 325 on the basis of exposure timing defined based on the go-around of the transfer belt 26a. The exposure (serial) data is supplied to the exposing unit 23.

Accordingly, an electrostatic latent image of the cyan (C) image is formed on the photoconductive drum 21 in accordance with C image light irradiated to the photoconductive drum 21 from the exposing unit 23. The cyan (C) electrostatic latent image is developed by the C developing unit 25C. That is, a cyan toner image is formed on the photoconductive drum 21.

Since the black toner image has been already transferred to the transfer belt 26a, the photoconductive drum 21 is exposed to the cyan image light at predetermined timing which is set so that the cyan toner image will be superimposed on the black toner image on the transfer belt 26a to which the black toner image has been already transferred.

The cyan toner image formed on the photoconductive drum 21 is carried to an intermediate transfer position where the photoconductive drum 21 and the transfer belt 26a come into contact with each other, in accordance with rotation of the photoconductive drum 21, so that the cyan toner image is superimposed on the black toner image. On this occasion, a cyan intermediate transfer bias voltage Vtc larger in absolute value than the black intermediate transfer bias voltage Vtbk is applied to the intermediate transfer member 26d from the bias power supply unit 129.

Accordingly, while the black toner image having been already transferred to the transfer belt 26a is prevented from being pulled back to the photoconductive drum 21, the cyan toner image is superimposed on the black toner image on the transfer belt 26a and transferred to the transfer belt 26a.

The cyan toner image transferred to the transfer belt 26a is moved together with the black toner image successively in accordance with movement of the belt surface of the belt 26a. Since the transfer unit 27 is made to retreat to the non-transfer position, the cyan toner image and the black toner image are carried toward the intermediate transfer position again.

On the other hand, while a remaining toner not transferred to the transfer belt 26a is removed from the surface of the photoconductive drum 21 after the transfer of the cyan toner image to the transfer belt 26a, the surface potential of the photoconductive drum 21 is returned to a potential distribution before a predetermined potential is given from the electrostatic charging unit 22.

Then, the developing roller of the magenta (M) developing unit 25M in the color developing unit 25 is rotated around the center shaft 25A, for example, in a direction of the arrow until the developing roller of the magenta (M) developing unit 25M faces the photoconductive drum 21, so that a magenta toner image is formed and transferred to the transfer belt 26a via a process similar to the aforementioned transfer of the cyan toner image.

Further, the developing roller of the yellow (Y) developing unit 25Y in the color developing unit 25 is rotated around the center shaft 25A, for example, in a direction of the arrow until the developing roller of the yellow (Y) developing unit 25Y faces the photoconductive drum 21, so that a yellow toner image is formed and transferred to the transfer belt 26a via a process similar to the aforementioned transfer of the cyan toner image.

In this manner, the Y toner image is transferred to the transfer belt 26a so as to be superimposed on the black toner image, the C toner image and the M toner image which have been already transferred to the transfer belt 26a.

Incidentally, as long as a transfer voltage provided to the transfer charge supply roller 26d is set preferably, each or any two or more of the BK, C and M toner images which have been already transferred to the transfer belt 26a can be superimposed on one another (transferred) on the transfer belt 26a while prevented from being pulled back to the photoconductive drum 21.

Then, the Y toner image transferred to the transfer belt 26a is carried, together with the black toner image, the C toner image and the M toner image, toward the intermediate transfer position in accordance with movement of the belt surface of the transfer belt 26a.

On the other hand, while a remaining Y toner not transferred to the transfer belt 26a is removed from the surface of the photoconductive drum 21 after the transfer of the Y toner image to the transfer belt 26a, the surface potential of the photoconductive drum 21 is returned to a potential distribution before a predetermined potential is given from the electrostatic charging unit 22.

In this manner, a color toner image corresponding to image data read by the image reader portion 10 and stored in the image memory 323 is formed on the transfer belt 26a.

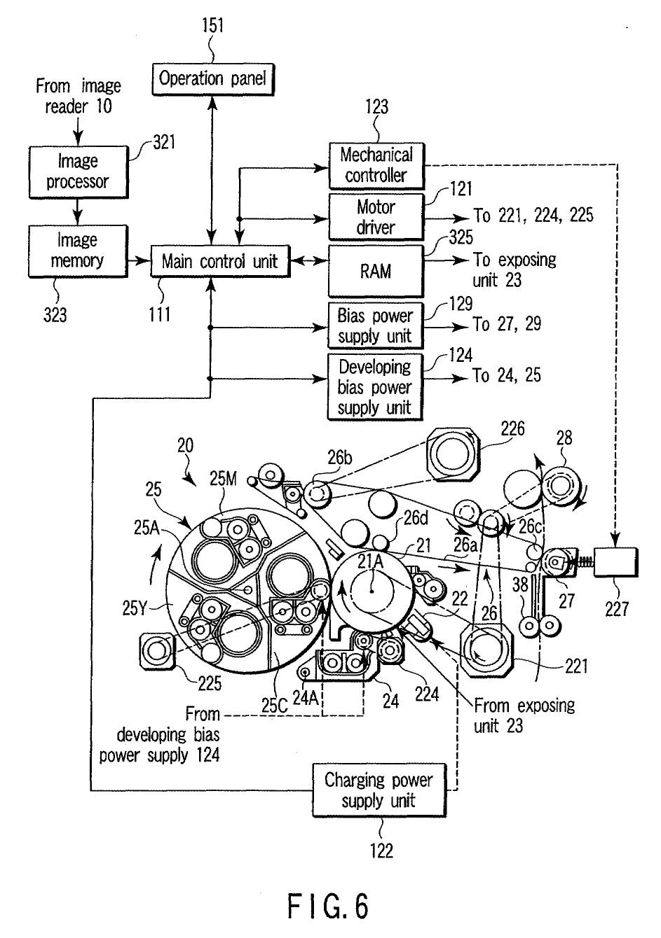

Incidentally, the roller member 26b may be configured so that a drive force from a drive mechanism (motor) 226 for exclusive use is transmitted to the roller member 26b as shown in FIG. 6.

As described above, in accordance with embodiments of this invention, in a color image forming apparatus of the type of superimposing toner images on one another, a torque limiter for absorbing a variation of load at the time of rotation of the intermediate transfer belt 26a which is the cause of a color shift is added to the drive roller shaft of the intermediate transfer belt unit to stabilize directly and positively the rotation of the drive roller of the intermediate transfer belt to thereby make it possible to provide an image forming apparatus with an inexpensive and simple structure in which the color shift hardly occurs.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
a toner image holding unit configured to hold a toner image corresponding to image data;
a toner image holding unit drive mechanism configured to move the toner image holding unit at a constant velocity in a predetermined direction;
a drive force generating unit configured to provide a thrust to rotate the toner image holding unit drive mechanism at a predetermined rotational velocity; and
a drive force control unit configured to provide the thrust generated by the drive force generating unit to the toner image holding unit drive mechanism while keeping the thrust in a constant thrust range.

2. The image forming apparatus according to claim 1, wherein the drive force control unit suppresses a velocity of the toner image holding unit drive mechanism from changing.

3. The image forming apparatus according to claim 1, wherein the drive force control unit suppresses a velocity provided to the toner image holding unit by the toner holding unit drive mechanism from changing when an external force acts on the toner image holding unit.

4. The image forming apparatus according to claim 1, wherein the drive force control unit suppresses a velocity of a constant reaction against rotation of the toner image holding unit drive mechanism from changing.

5. The image forming apparatus according to claim 1, further comprising:
a latent image holding member configured to hold a latent image used in the toner image to be held on the toner image holding unit;
a toner image forming unit configured to provide a toner to the latent image held on the latent image holding member and to make the toner image to be transferred to the toner image holding unit; and
a first toner image transfer unit configured to transfer the toner image made by the toner image forming unit to the toner image holding unit.

6. The image forming apparatus according to claim 5, further comprising:
a second toner image transfer unit configured to attract the toner image held on the toner image holding unit to a transfer material interposed between the second toner image transfer unit and the toner image holding unit.

7. The image forming apparatus according to claim 6, wherein each of the toner image transfer units provides a predetermined electric field to the toner image forming unit from the toner image holding unit side while pressing the toner image holding unit against the toner image forming unit.

8. An image forming apparatus comprising:
a belt member, shaped belt like and has a belt surface, configured to hold a toner image corresponding to image data is transferred;
a roller member configured to move the belt surface at a constant velocity in a predetermined direction while giving a predetermined tension to the belt member;
a roller drive device configured to rotate the roller member at a predetermined rotational velocity; and
a drive force stabilizing device, located between the roller member and a structural body supporting the roller member, configured to absorb a rotation irregularity component or a velocity change occurring in the belt member.

9. The image forming apparatus according to claim 8, wherein the drive force stabilizing device gives a predetermined amount of load to the roller member rotated at a predetermined velocity by the roller drive device.

10. The image forming apparatus according to claim 9, wherein the drive force stabilizing device always gives a predetermined amount of braking force to the roller member rotated at a predetermined velocity by the roller drive device.

11. A method for forming an image comprising:
generating a toner image on a latent image holding member;
transferring the generated toner image to a toner image carrying belt by an electric field, the toner image carrying belt having a toner image holding surface moved at a constant velocity through a drive shaft supplied with a constant load; and
transferring the toner image carried by the toner image carrying belt, to a transfer material.

12. The method according to claim 11, wherein the constant load supplied to the drive shaft is provided through a torque limiter which is provided so as to be integrated with the drive shaft.

13. The method according to claim 12, wherein the torque limiter provides a predetermined reaction against a turning force provided to the drive shaft.
